(19) United States
(12) Patent Application Publication
(10) Pub. No.: US 2005/0166150 A1
(43) Pub. Date: Jul. 28, 2005

(54) Method and system for effect addition in video edition

(76) Inventor: Sandy Chu, Taipei City (TW)

Correspondence Address: BIRCH STEWART KOLASCH & BIRCH, PO BOX 747, FALLS CHURCH, VA, 22040-0747, US

(21) Appl. No.: 10/763,331

(22) Filed: Jan. 26, 2004

(51) Int. Cl. G11B 27/00; G06F 3/00; H04N 5/93

(52) U.S. Cl. 715/723; 715/724; 715/725; 715/726; 715/730; 386/52

(57) ABSTRACT

A method and system for effect addition in video edition is disclosed. Firstly, one or more video clips are selected and arranged. The selected video clips are scanned by scene scanning to generate effect marking-in points. Then effects can be added on the effect marking-in points according to a default effect type and its default duration. This will be convenient for user to proceed the video edition afterward.

### BACKGROUND OF THE PRESENT INVENTION

1. Field of the Invention

The invention relates to a method and method for effect addition, and more particularly, to a method and method for automatic effect addition.

2. Description of the Prior Art

In a film, actors and scenes would change often. It results from the intermittent recording or the assembly of many different clips. A scene within the film may not be in harmony with the other scenes, so it needs some effects to enrich the entire contents and reduce the disharmony.

There is lots of software providing for effect addition, and users can edit video more conveniently. However, many operations of effect addition need to be completed manually. For example, the making mark in point to add effect, and adjusting the duration of an effect or the type of an effect. All of them have to be made by hand. If it takes a long time to play a video or there are lots of scenes within the video, a user must browse it entirely and sequentially mark-in mark in points for effect addition. Obviously, it will be very inefficient.

In addition, a video may be formed with many clips. Each of the clips may be made by different people or in different manners, thus the format of the clips may also be different. Hence, it could be disharmonious if a video is formed with clips and effect of each of is added separately. Moreover, it takes extra work to convert all clips into a signal format because of their different formats. Thus, the better way to deal with this is to integrate all clips into an integrated clip first and to add effect thereafter. However, it takes same time and same efforts to pick up preferred scene change points and to add effects on them by hand. Besides, it could be more complicated, but it could be more harmonious.

In the prior art, there are two manners to edit multi-clips. The first manner, referring to FIG. 1A, step 110 imports a plurality of clips firstly. Then step 120 transfers and joins all clips to be an integrated clip. Next, step 130 browses the integrated clip and makes mark in points sequentially. Generally speaking, a user must browse whole integrated video at least once to complete the editing. If the length of the integrated video is very long and there are lots of mark in points needed to be made, it will take a large amount of time.

Another manner is shown in FIG. 1B. Firstly step 150 imports a clip for effect addition sequentially. Then step 160 browses each clip and makes mark in points sequentially. Finally step 170 integrates each clip. Namely, effect addition in each clip is made separately and all clips are integrated after effect addition in them are all finished in the second manner. The cost of time and efforts in the second manners is the same as in the first manner. But the integrated clip made by the second manner may appear more disharmonious.

Obviously, the forgoing work may need to integrate several different format clips and make mark in points sequentially by hand. Hence it requires a convenient and efficient method or system to help users integrate several clips with effect addition.

### SUMMARY OF THE PRESENT INVENTION

One main purpose of the present invention is to provide a method and system for video editing to pre-select mark in points and add effect on them. Users can save time and efforts to proceed video editing thereafter.

According to the purposes described above, the present invention provides a method for effect addition in video edition. By selecting and arranging one or more clips, the scene scan is used to find out the mark in points. Then effects can be added at the position where the mark in points are according to a pre-configured effect type and effect duration. Users can save time and efforts to proceed video editing thereafter.

The present invention also presents a system for effect addition in video edition, comprising importing model for selecting, importing and arranging a plurality of clips as a successive clip; configuration model for configuring and storing an effect type and an effect duration corresponding to the effect type to form the setting of an effect; mark in model for making a plurality of mark in points by using a scene scan, wherein the plurality of mark in points are stored in a mark in point storage; and effect model for adding effects to the plurality of mark in points according to the effect type and the effect duration.

### BRIEF DESCRIPTION OF THE DRAWINGS

A better understanding of the present invention can be obtained when the following Detailed Description is considered in conjunction with the following drawings, in which:

FIG. 1A and FIG. 1B are the diagrams of the prior art;

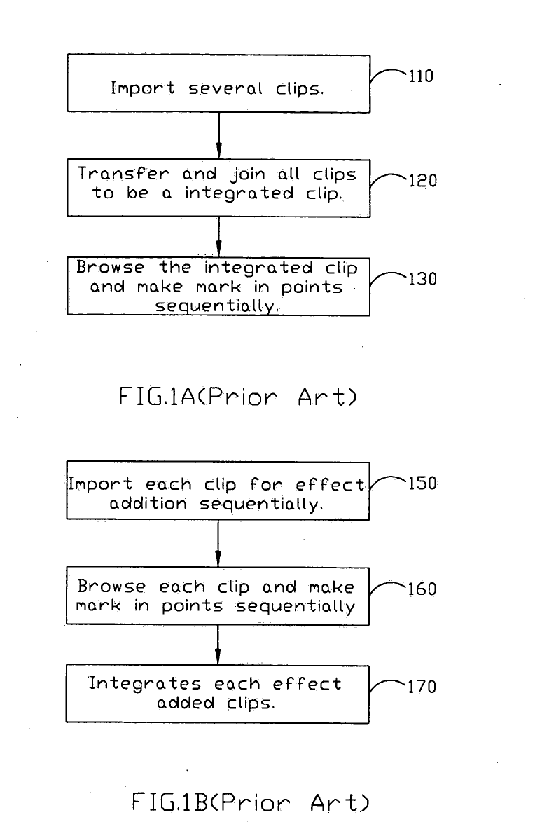

FIG. 2 is a flow diagram of one embodiment of the present invention; and

FIG. 3 is a diagram of another embodiment of the present invention.

### DETAILED DESCRIPTION OF THE PREFERRED EMBODIMENT

For conveniently and efficiently making mark in points and adding effect on the mark in points within one or more clips, the present invention provides a method and system for effect addition in video editing. In the present invention, several clips can be imported simultaneously and all imported clips can be transformed into a single format and effect addition can be on the joint between clips, user pre-defined mark in points and scene change point. The selection of the forgoing scene change can be done in different manners depending on the format of each clip. For example, the selection can be done according to the recording time if the clip is based on the format with recording time.

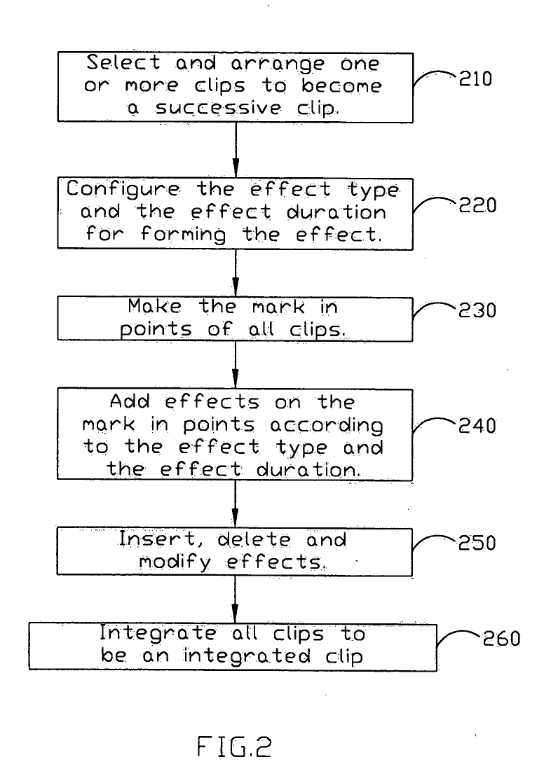

Referring to FIG. 2, a flow diagram of one embodiment of the present invention is shown. Firstly, step 210 selects and arranges one or more clips to become a successive clip. The format of each clip can be different, i.e. mpeg, avi, rm, vcd, svcd or the like. The present invention does not limit the file format. The arranged clips are successive and do not overlap each other. Next, step 220 configures the effect type and the effect duration for forming the effect, wherein the effect type and the effect duration can be default or user pre-defined.

Then, step 230 makes the mark in points of all clips, wherein the manner to make the mark in points can be selected according to the joint between clips, the point where scene information is and the point where scene changes. If the number of clips is more than one, there must be at least one joint between clips. The joints can be the mark in points. Besides, some clips may be added with some scene information before or after they are imported. The scene information can be audio, graph, or text. For example, the scene information can be the chapter information, cue information made by user, or some scene information made during recording (i.e. snap shot). Besides, it can be beat tracking rhythm or tempo and so forth that can be used for accompanying scene change or scene contents. Each beat tracking rhythm or tempo can be considered as an individual scene information. The point of the scene information can be the mark in points, too.

Furthermore, there may be many scene change points within the clips. A scene is usually formed by several successive frames with similar foregrounds or backgrounds. Within the scene transition, the frame between two scenes could be the one that is much different from one or more forward frames or afterward frames. Thus the points at scene transition can be selected to be mark in points by using scene scan. The scene scan has disclosed a lot (i.e. the method for detecting changes in the video signal at block 115 taught by Jonathan Foote disclosed in the USPTO publication “METHOD FOR AUTOMATICALLY PRODUCING MUSIC VIDEOS (US2003/0160944)”) and no redundant description will be stated here.

The difference between a frame and other frames (i.e. one or more forward frames or afterward frames) is called a scene scan sensitivity. Mark in points can be selected according to the scene scan sensitivity of each frame by using scene scan. For example, there is a default scene scan sensitivity threshold and all frames with scene scan sensitivity larger than the scene scan sensitivity threshold can be selected as mark in points. Moreover, mark in points can be made by users also.

In addition, some clips recorded by some specific format, such as DV (digital video), include some recording time. The recording time may be recorded in the beginning or the end of a scene, or added when some specific functions (i.e. snap shot) are performed. The recording time is more suitable for the mark in points than the scene change points. Users can use scene scan to make all mark in points by default, but the specific format clips with recording time can optionally use the recording time to be mark in points rather than scene scan.

After making mark in points, step 240 adds effects on the mark in points according to the effect type and the effect duration configured in step 220. Because the effect type and the effect duration are used for adding effects, they could be varied for different conditions or different demands. The time and times for step 220 are not limited in the present invention. For examples, the step 220 could be made both before and after step 230 and so forth. Furthermore, the step 220 can be made during step 240 for dynamically adjusting the effect duration or changing the effect type. The effect can be half a duration before and after a mark in point, a duration before a mark in point, a duration after a mark in point or the so forth. The present invention does not limit the position for effect addition.

Moreover, A mark in points filtering can be performed before effect addition. For examples, a mark in point may be filtered out when it overlaps another effect and it is in the later scan order. Furthermore, the mark in points filtering can also be effect duration adjusting. For examples, the effect duration of a mark in point may be adjusted for avoid overlapping when it overlaps another effect and it is in the later scan order. However, the present invention does not limit the way to filter or to adjust the mark in points.

Furthermore, the above mentioned step 230 and step 240 can be integrated as a automatic effect addition procedure. And the related configuration for the effect type and the effect duration, the configuration for scene scan sensitivity threshold, filtering mark in points, making user pre-defined mark in points can be performed before the automatic effect addition procedure. Thus, the automatic effect addition procedure can be used as an automatic effect addition function, such as the one-click function in some software, to be more convenient and user-friendly.

As well, the present invention also includes the function for inserting, deleting and modifying effects. Referring to step 250, users can not only delete unsatisfied effects, but also insert effects by hand. Besides, user can also change the effect type or the effect duration of an effect. Thus, the present invention does not only save lots of cost to select make in points and to add effects manually, but also has the flexibility to let user make advanced amendment. Finally, step 260 integrates all clips to be an integrated clip.

In fact, most of the points of the above mentioned scene information, joints between clips and recording time are where the scene changes. So scene scan could find out most of them and they are suitable to be mark in points. But it is possible that some of them do not locate at where the scene changes. Thus, the way to add mark in points according to scene information, joints between clips, recording time or user pre-defined position by hand can be made before or after the scene scan, and the effect addition can be performed directly when these mark in points are found.

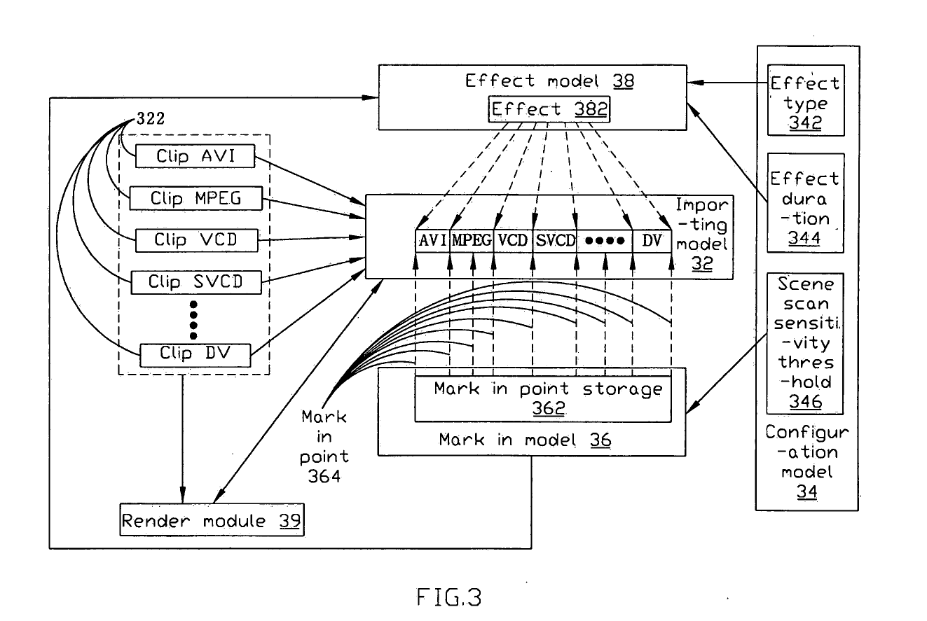

Accordingly, referring to FIG. 3, another embodiment of the present invention is a system for effect addition in video edition, including importing model 32, configuration model 34, mark in model 36, effect model 38 and render module 39. The importing model is used to select, import and arrange one or more clips 322 according step 210. Moreover, configuration model 34 is used to store effect type 342, effect duration 344 and scene scan sensitivity threshold for configuring the effect 382 according to step 220. Afterward, mark in model 36 is used to make the mark in points 364 for each clip 322 and store the mark in points 364 in the mark in points storage 362 according to step 230. When the mark in model 36 are used for making the mark in points 364 by using scene scan, the mark in points 364 is made according to the scene scan sensitivity threshold 346 in the configuration model 34. Next, effect model 38 is used to add effects 382 at all mark in points of each clip 322 according to step 240, wherein the effects 382 is generated according effect type 342 and effect duration 344. Besides, the mark in model can filter out some unsuitable mark in points 364 according to step 250.

Finally, render model 39 is used to integrate all clips 322 into an integrated clip according to step 260. Furthermore, the render model 39 can further integrate all clips 322 into an integrated clip firstly. Then the integrated clip can be imported to importing model 32 according to step 210 to proceed the following step 220, step 230, step 240 and step 250. Finally, the render model 39 is used to integrate and output the effect added integrated clip. Because only the integrated clip is imported, the work to make mark in points according to the joins between clips can be ignored.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. A method for effect addition in video edition, comprising:
selecting and arranging a plurality of clips, wherein said plurality of clips being arranged as a successive clip;
making a plurality of mark in points of said plurality of clips, wherein said mark in points being made by using a scene scan; and
adding effects to said plurality of mark in points.

2. The method according to claim 1, wherein said plurality of clips includes different formats.

3. The method according to claim 1, wherein said mark in points are further made according to the joints between clips.

4. The method according to claim 1, wherein said mark in points are further made according to where the scene information are.

5. The method according to claim 1, wherein said scene information can be selected from the audio, graphic and text.

6. The method according to claim 1, wherein scene scan is used to generate a scene scan sensitivity of each frame of said plurality of clips.

7. The method according to claim 6, wherein said plurality of mark in points are made by comparing said scene scan sensitivity with a scene scan sensitivity threshold.

8. The method according to claim 1, further comprising making said mark in points manually by users.

9. The method according to claim 8, wherein said making said mark in points manually by users is before making said plurality of mark in points by using said scene scan.

10. The method according to claim 1, further comprising making said plurality of mark in points according to the recording time when said clip includes said recording time.

11. The method according to claim 1, further comprising configuring an effect type and an effect duration for forming an effect, wherein said effects are added to said plurality of mark in points according to said effect type and said effect duration.

12. The method according to claim 11, further comprising filtering out said mark in points, wherein said mark in point is filtered out when the range of the adding effect on said mark in point according to said effect type and said effect duration overlaps the range of another said mark in point and the scan order of said mark in point is later than said another mark in point.

13. The method according to claim 11, further comprising adjusting said effect duration of said mark in point, wherein said mark in point is adjusted when the range of the adding effect on said mark in point according to said effect type and said effect duration overlaps the range of another said mark in point and the scan order of said mark in point is later than said another mark in point.

14. A system for effect addition in video edition, comprising:
importing model for selecting, importing and arranging a plurality of clips as a successive clip;
configuration model for configuring and storing an effect type and an effect duration for forming the setting of an effect;
mark in model for making a plurality of mark in points by using a scene scan, wherein said plurality of mark in points being stored in a mark in point storage; and
effect model for adding effects to said plurality of mark in points according to said effect type and said effect duration.

15. The system according to claim 14, wherein said plurality of clips includes different formats.

16. The method according to claim 14, further comprising rendering model for joint and integrating said plurality of clips to become an integrated clip.

17. The system according to claim 14, wherein said mark in model further comprises making said plurality mark in points according to the joints between clips.

18. The system according to claim 14, wherein said mark in model further comprises making said plurality mark in points according to where the scene information are.

19. The system according to claim 18, wherein said scene information can be selected from the audio, graphic and text.

20. The system according to claim 14, wherein scene scan is used to generate a scene scan sensitivity of each frame of said plurality of clips.

21. The system according to claim 20, wherein said plurality of mark in points are made by comparing said scene scan sensitivity with a scene scan sensitivity threshold.

22. The system according to claim 14, wherein said mark in model further comprises making said mark in points manually by users.

23. The system according to claim 22, wherein said making said mark in points manually by users is before making said plurality of mark in points by using said scene scan.

24. The system according to claim 14, said mark in model further comprises making said plurality of mark in points according to the recording time when said clip includes said recording time.

25. The system according to claim 14, wherein said effects are added to said plurality of mark in points according to said effect type and said effect duration.

26. The system according to claim 25, said mark in model further comprises filtering out said mark in points, wherein said mark in point is filtered out when the range of the adding effect on said mark in point according to said effect type and effect duration overlaps the range of another said mark in point and the scan order of said mark in point is later than said another mark in point.

27. The system according to claim 25, said mark in model further comprises adjusting said mark in points, wherein said mark in point is adjusted when the range of the adding effect on said mark in point according to said effect type and effect duration overlaps the range of another said mark in point and the scan order of said mark in point is later than said another mark in point.
